(19) United States
(12) Patent Application Publication
(10) Pub. No.: US 2014/0241949 A1
(43) Pub. Date: Aug. 28, 2014

(54) RADIANT HEAT TUBE CHEMICAL REACTOR

(71) Applicant: Sundrop Fuels, Inc., Longmont, CO (US)

(72) Inventors: Christopher Perkins, Boulder, CO (US); Wayne W. Simmons, Longmont, CO (US); Paul Lichty, Westminster, CO (US)

(73) Assignee: Sundrop Fuels, Inc., Longmont, CO (US)

(21) Appl. No.: 14/278,313

(22) Filed: May 15, 2014

Related U.S. Application Data
(63) Continuation-in-part of application No. 13/429,752, filed on Mar. 26, 2012.
(60) Provisional application No. 61/823,661, filed on May 15, 2013.

(51) Int. Cl. B01J 6/00; B01J 12/00

(52) U.S. Cl. CPC B01J 6/008; B01J 12/005
USPC 422/162

(57) ABSTRACT

A radiant heat-driven chemical reactor comprising a generally cylindrical pressure refractory lined vessel, a plurality of radiant heating tubes, and a metal tube sheet to form a seal for the pressure refractory lined vessel near a top end of the pressure refractory lined vessel. The metal tube sheet has a plurality of injection ports extending vertically through the metal tube sheet and into the refractory lined vessel such that biomass is injected at an upper end of the vessel between the radiant heating tubes, and the radiant heat is supplied to an interior of the plurality of radiant heating tubes. The radiant heat-driven chemical reactor is configured to 1) gasify particles of biomass in a presence of steam (H2O) to produce a low CO2 synthesis gas that includes hydrogen and carbon monoxide gas, or 2) reform natural gas in a non-catalytic reformation reaction, using thermal energy from the radiant heat.

### RELATED APPLICATIONS

This application claims the benefit of and priority to U.S. Provisional application, entitled “BAYONET ARCHITECTURE RADIANT HEAT REACTOR,” Ser. No. 61/823,661, filed on May 15, 2013 as well as is a Continuation in part of U.S. patent application, entitled “VARIOUS METHODS AND APPARATUSES FOR INTERNALLY HEATED RADIANT TUBES IN A CHEMICAL REACTOR,” Ser. No. 13/429,752 filed on Mar. 26, 2012, which are both incorporated herein by reference.

### FIELD

The design generally relates to bayonet architecture radiant heat reactor. In an embodiment, the design relates to an integrated plant that uses this biomass to produce a liquid fuel from the biomass gasified in the bayonet architecture radiant heat reactor.

### BACKGROUND

Complex, capital intensive, reactors that require large amounts of energy have tried to convert organic material into a useable fuel. A good reactor design is needed.

### SUMMARY

In an embodiment, a chemical plant that may include a radiant heat-driven chemical reactor that has a generally cylindrical pressure refractory lined vessel is discussed. The radiant heat-driven chemical reactor may have a plurality of radiant heating tubes that extend throughout an upper section of the refractory lined vessel. A metal tube sheet forms a seal for the pressure refractory lined vessel of the reactor near a top end of the pressure refractory lined vessel. The metal tube sheet has a plurality of injection ports extending generally vertically through the metal tube sheet and into the refractory lined vessel, such that the particles of biomass are injected at an upper end of the vessel. The pressure refractory lined vessel, the plurality of radiant heating tubes, and the plurality of injection ports, all extend through the metal tube sheet in order to 1) gasify the particles of biomass in a presence of steam (H2O) to produce a synthesis gas that includes hydrogen, carbon monoxide gas and less than 15% CO2 by total volume generated in a gasification reaction of the particles of biomass. The radiant heat-driven chemical reactor may also 2) reform natural gas in a non-catalytic reformation reaction, using thermal energy primarily from the radiant heat. The radiant heating tubes are arranged in an interior cavity of the vessel along with multiple injection ports such that an injection of 1) the particles of biomass, 2) the natural gas, and 3) any combination of both, flows through a length of the refractory lined vessel.

The vessel further includes two or more outlet ports for removing solids and gasses from the vessel. A first port cooperates with an ash removal mechanism configured to remove ash remnants resulting from the gasification reaction or reformation reaction. A second port is configured to remove resultant product gasses from a lower portion of the vessel. Note, the second port for product gasses is located above the ash removal mechanism such that less ash and particulate are being carried out of an exit of the chemical reactor along with the departing resultant product gasses.

The chemical reactor is in fluid communication with a source of the steam, such as a boiler. The one or more radiant heating tubes and the refractory lined vessel are geometrically configured to cooperate such that heat is radiantly transferred to 1) the particles of biomass, and/or 2) the natural gas passing through the vessel. The radiant heating tubes and steam cooperate in order to provide enough energy required for the 1) gasification reaction of the particles of biomass, 2) the non-catalytic reformation of the natural gas, and 3) any combination of both, in order to drive the reaction primarily with radiant heat to produce the synthesis gas with a low amount of CO2. The one or more radiant heating tubes and the refractory lined vessel are geometrically configured to cooperate such that heat is radiantly transferred by primarily absorption and re-radiation, as well as secondarily through convection and conduction to the reacting particles to drive the biomass gasification reaction, or natural gas reformation reaction, of reactants flowing through the reactor tubes. A heat source, such as gas fired heaters, in thermal communication with the radiant heating tubes internally heats each tube such that heat exchanges through the wall of each tube to an interior environment of the refractory lined vessel where 1) the particles of biomass, 2) natural gas, or 3) any combination of both is flowing to cause an operating temperature of between 900 degrees C. to 1600 degrees C. in the chemical reactor.

### BRIEF DESCRIPTION OF THE DRAWINGS

The multiple drawings refer to the example embodiments of the design.

FIG. 1 illustrates a flow schematic of an embodiment of a steam explosion unit having an input cavity to receive biomass as a feedstock, two or more steam supply inputs, and two or more stages to pre-treat the biomass for subsequent supply to a biomass gasifier.

FIG. 2 illustrates an embodiment of a flow diagram of an integrated plant to generate syngas from biomass and generate a liquid fuel product from the syngas.

FIG. 3-1 is a side section view of an exemplary embodiment of a radiant heat reactor having a bayonet reactor design.

FIG. 3-2 is a top view of an exemplary embodiment of a radiant heat reactor having a bayonet reactor design.

FIG. 3-3 is a schematic illustrating an alternative architecture of a fountain gasifier design of a radiant heat reactor.

FIG. 3-4 is a schematic illustrating an embodiment of a radiant heat reactor.

FIGS. 4A-C illustrates different levels of magnification of an example chip of biomass having a fiber bundle of cellulose fibers surrounded and bonded together by lignin.

FIG. 4D illustrates example chips of biomass exploded into fine particles of biomass.

FIG. 4E illustrates a chip of biomass having a bundle of fibers that are frayed or partially separated into individual fibers.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific chemicals, named components, connections, types of heat sources, etc., in order to provide a thorough understanding of the present design. It will be apparent, however, to one skilled in the art that the present design may be practiced without these specific details. In other instances, well known components or methods have not been described in detail but rather in a block diagram in order to avoid unnecessarily obscuring the present design. Thus, the specific details set forth are merely exemplary. The specific details may be varied from and still be contemplated to be within the spirit and scope of the present design. Characteristics and components used in one embodiment may, in some instances, be used in another embodiment.

In general, a number of example processes for and apparatuses associated with a radiant heat-driven reactor are described. The following drawings and text describe various example implementations for an integrated plant using pre-treatments of biomass with a radiant heat tube reactor design. In an embodiment, a chemical plant includes a radiant heat-driven chemical reactor comprising a generally cylindrical pressure refractory lined vessel, a plurality of radiant heating tubes, and a metal tube sheet to form a seal for the pressure refractory lined vessel near a top end of the pressure refractory lined vessel. The metal tube sheet has a plurality of injection ports extending generally vertically through the metal tube sheet and into the refractory lined vessel such that biomass is injected at an upper end of the vessel and the radiant heat is supplied via the plurality of radiant heating tubes.

The radiant heat-driven chemical reactor may be configured to 1) gasify particles of biomass in a presence of steam (H2O) to produce a low CO2 synthesis gas that includes hydrogen and carbon monoxide gas, or 2) reform natural gas in a non-catalytic reformation reaction, using thermal energy from a radiant heat source, such as gas heaters, concentrated solar energy, or other source. The vessel further includes one or more outlet ports for removing solids and gasses from the vessel. An ash removal mechanism removes ash remnants resulting from the reactions at a lower end of the vessel, and a product gasses outlet valveport is located above the ash removal mechanism such that less ash and particulates being part of the product gasses exit the chemical reactor.

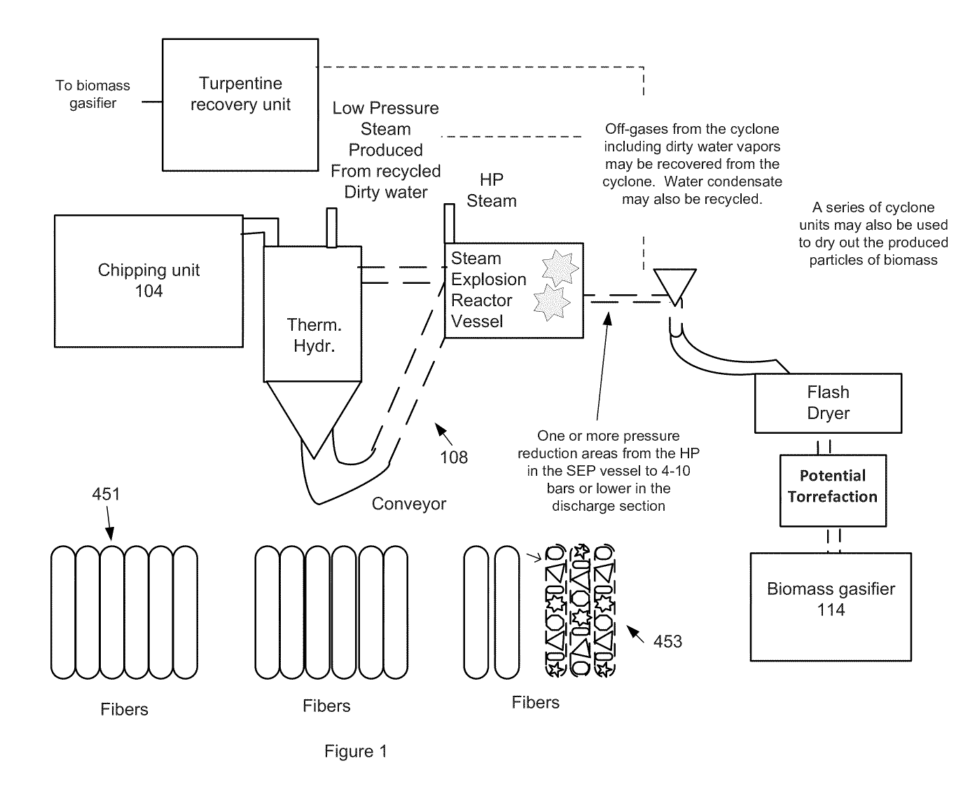

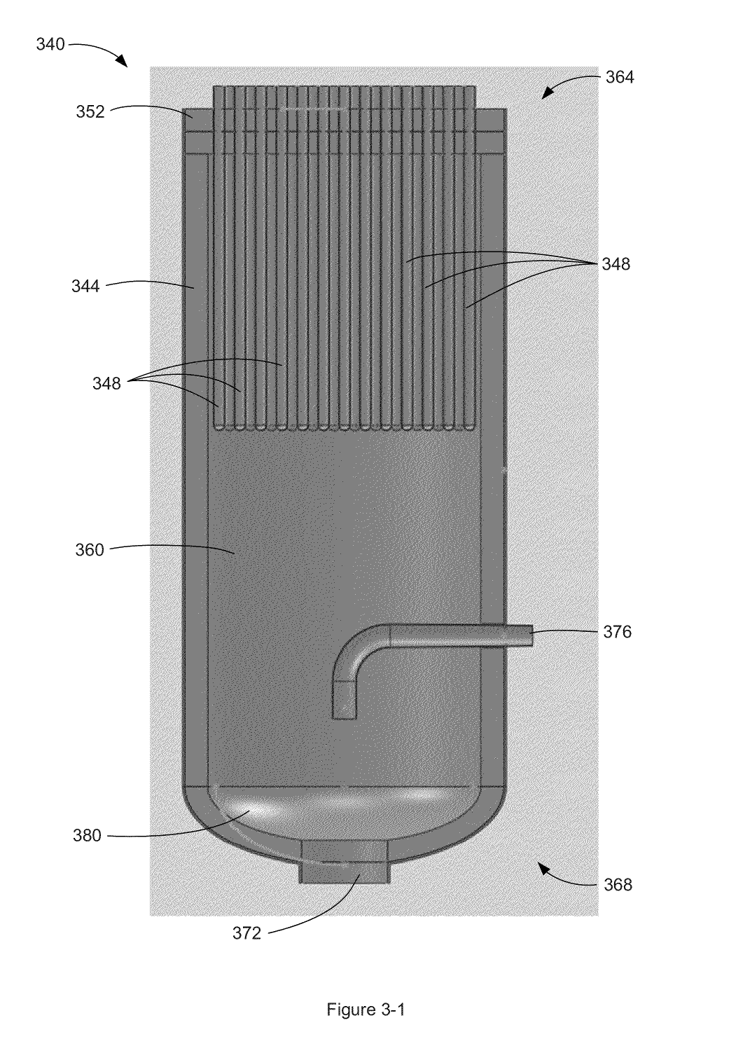

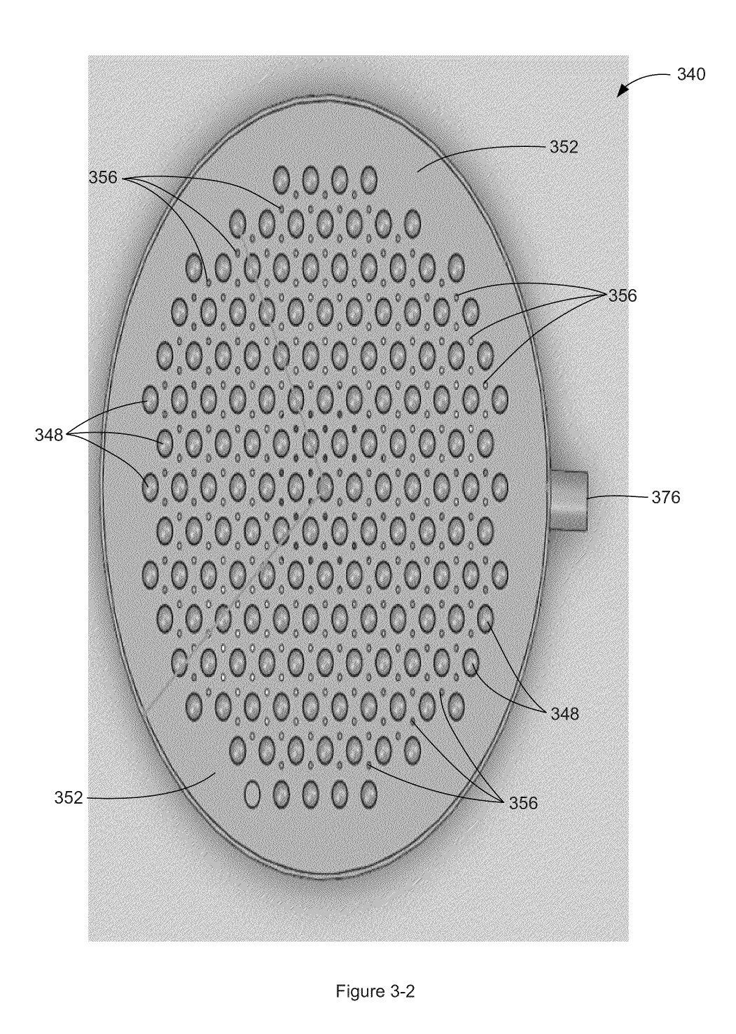

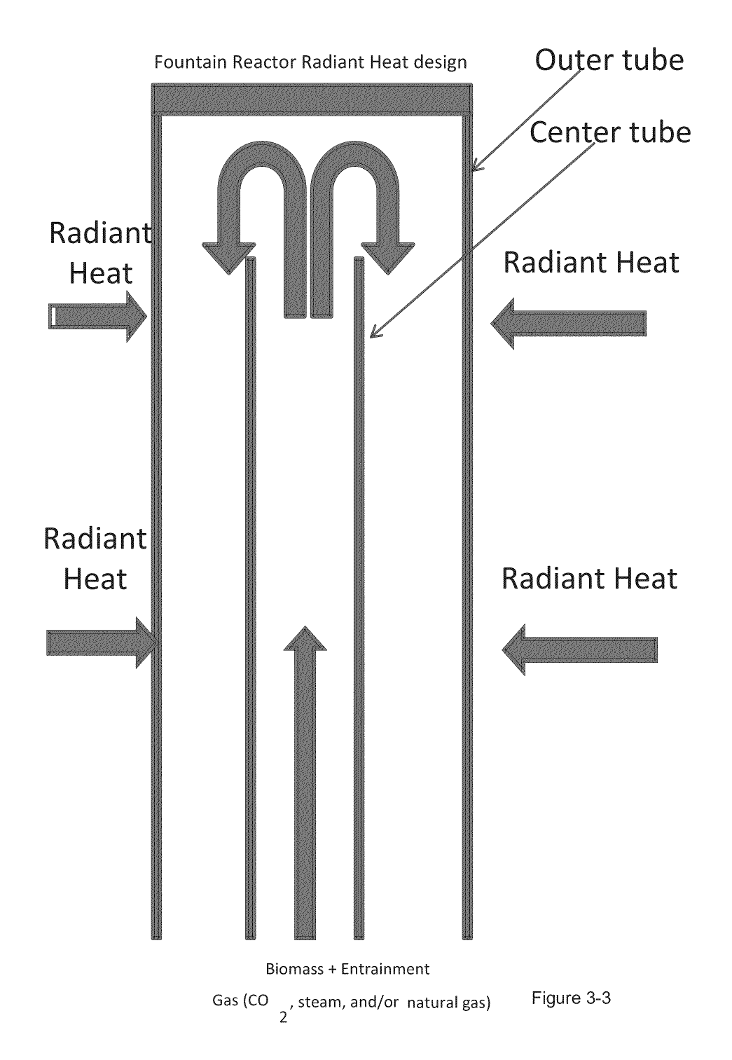

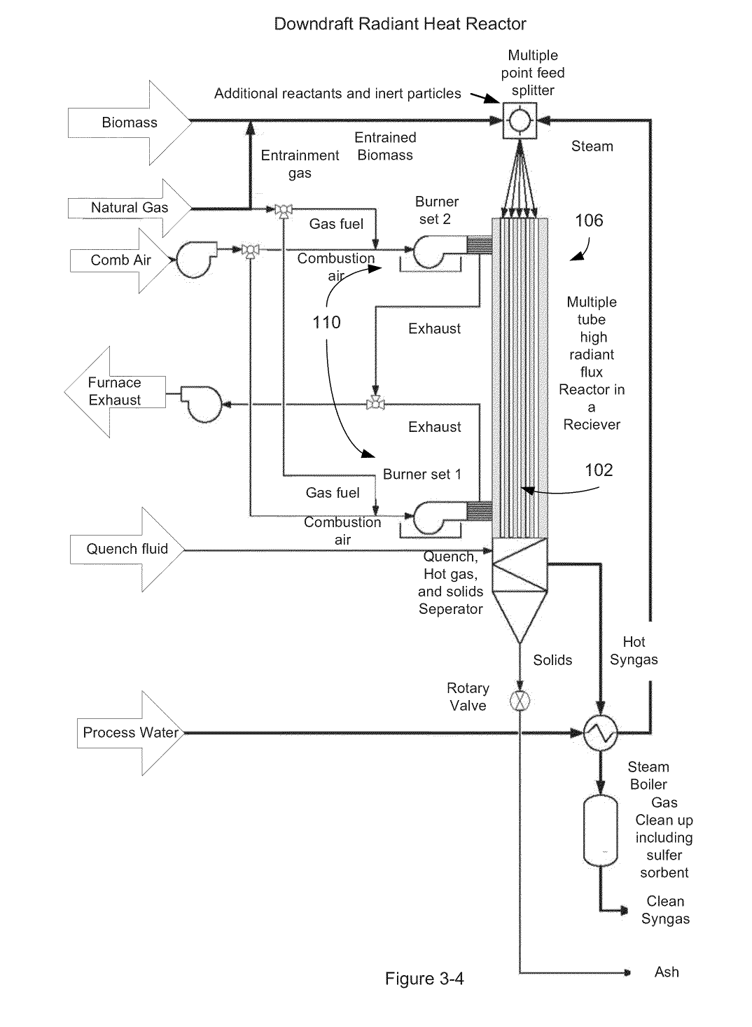

FIG. 3-1 illustrates an exemplary embodiment of a chemical plant comprising a radiant heat-driven chemical reactor 340 having generally a cylindrical pressure refractory lined vessel 344 with an interior cavity 360, a plurality of radiant heating tubes 348, and a metal tube sheet 352. The metal tube sheet 352 forms a seal for the pressure refractory lined vessel 344 near a top end of the vessel. The plurality of radiant heating tubes 348 extend through the metal tube sheet 352 and into an upper portion 364 of the refractory lined vessel 344. The refractory lined vessel 344 is generally vertical such that biomass is injected at the upper portion 364 of the vessel and radiant heat is supplied also at the upper portion 364 of the vessel by way of the plurality of radiant heating tubes 348. In an embodiment, the refractory lined cylindrical pressure vessel 344 has a diameter ranging between 5 feet and 24 feet, and comprises a layer of refractory material ranging between 1 inch and 24 inches in thickness. In an embodiment, the radiant heating tubes 348 are Hexoloy SiC sheathed burner tubes.

As best shown in FIG. 3-1, the plurality of radiant heating tubes 348 extend through the metal tube sheet 352 and each of the radiant heating tubes 348 is sealed into the metal tube sheet 352. It will be appreciated by those skilled in the art that pressure inside the refractory lined vessel 344 operates to push the radiant heating tubes 348 into the seals, thereby increasing the effectiveness of the seals. Further, the seals are located at the upper portion 364 where the biomass particles being injected into the refractory lined vessel 344 are subjected to a temperature cooler than a temperature of the reaction within the interior cavity 360 of the reactor vessel, thereby allowing the seals to be comprised of a material having a lower resistance to temperature than if the seals were positioned within the interior cavity 360 of the vessel. Thus, sealing the radiant heating tubes 348 to the metal tube sheet 352 is simpler than other, conventional techniques for sealing the tubes. Further, those skilled in the art will appreciate that the radiant heating tubes 348 may be either top or bottom loaded through the metal tube sheet 352. In an embodiment, the metal tube sheet 352 has a diameter which matches the diameter of the refractory lined vessel 344, and comprises a thickness ranging between 6 inches and 24 inches. Further, in some embodiments the radiant heating tubes 348 may be packed on either a triangular or square pitch. In an embodiment, the radiant heating tubes 348 have an inner diameter of 6 inches and are spaced on an 11-inch pitch.

A heat source is coupled to the radiant heat-driven chemical reactor 340 and configured to provide heat to the interior cavity 360 of the refractory lined vessel 344 by way of a plurality of radiant burners. Each of the radiant heating tubes 348 comprises a closed ceramic tube in which heat is supplied to the interior of the tube. Heat may be supplied to each of the radiant heating tubes 348 either by way of an integral burner or by way of an external burner which supplies a hot combustion gas to each of the radiant heating tubes 348. In some embodiments, each of the plurality of radiant heating tubes 348 comprises SiC in compression, due to pressure inside the refractory lined vessel 344. In an embodiment, the radiant heating tubes preferably have an inner diameter ranging between substantially 4 inches and 6 inches. In some embodiments, the inner diameter of the radiant heating tubes 348 may range between 3 inches and 12 inches.

The radiant heating tubes 348 extend into the interior cavity 360 of the refractory lined vessel 344 to heat the injected biomass or natural gas. As illustrated in FIG. 3-1, the radiant heating tubes 348 terminate prior to a lower end 368 of the refractory lined vessel 344. In other embodiments, however, the plurality of radiant heating tubes 348 may extend all the way through the refractory lined vessel 344. In the illustrated embodiment of FIG. 3-1, the radiant heating tubes 348 are aligned with a longitudinal axis of the refractory lined vessel 344 such that the tubes are oriented substantially parallel to a flow path of the injected biomass or natural gas. In another embodiment, however, the radiant heating tubes 348 may be aligned with a horizontal axis of the refractory lined vessel 344 such that the tubes are oriented substantially perpendicular to the flow path of the injected biomass or natural gas. In such an embodiment, the plurality of radiant heating tubes 348 may project from a side wall of the refractory lined vessel 344 and the heat source may be an external recuperative or regenerative burner that supplies hot gas to the plurality of radiant heating tubes 348 via a manifold.

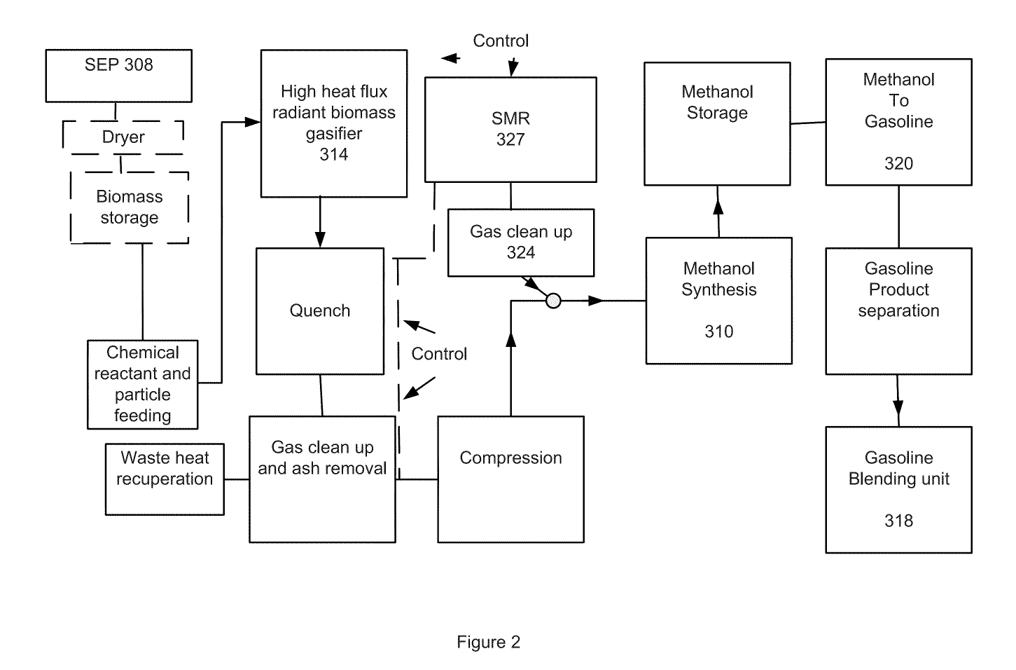

As illustrated in FIG. 3-2, the metal tube sheet 352 has a plurality of injection ports 356 extending through the metal tube sheet 352. An entrainment gas source coupled to the refractory lined vessel 344 is configured to provide the entrainment gas at a high enough velocity to carry the biomass particles entering the refractory lined vessel 344 by way of the injection ports 356, such that the biomass particles and the entrainment gas travel downward through the refractory lined vessel 344. In the embodiment illustrated in FIG. 3-2, the radiant heating tubes 348 and the injection ports 356 are attached to the top of the refractory lined vessel 344 such that the radiant heating tubes 348 and the corresponding injection ports 356 are interspersed in a grid pattern in the metal tube sheet 352. In other embodiments, the metal tube sheet 352 may include between 10 and 200 injection ports 356 which are configured for injecting biomass and the entrainment gas (CO2, steam, natural gas, or a mixture of these) at the upper end 364, between the radiant heating tubes 348, into the interior cavity 360 of the refractory vessel 344. In some embodiments, wherein the spacing atop the metal tube sheet 352 is particularly tight, the injection ports 356 may enter the refractory lined vessel 344 between the metal tube sheet 352 and the refractory lining of the vessel 344. In other embodiments, the refractory lined vessel 344 may further include biomass injection ports positioned along the cylindrical side of the refractory lined vessel 344 so as to inject biomass along a length of the plurality of radiant heating tubes 348. Biomass injection ports along the cylindrical side of the vessel facilitate a substantially uniform heat flux distribution along the length of the plurality of radiant heating tubes 348.

In some embodiments, a portion of the plurality of injection ports 356 may be used for injecting biomass particles into the interior cavity 360, while the remaining portion of injection ports 356 may be used for injecting gases into the interior cavity 360. It will be recognized that the plurality of injection ports 356 facilitates controlling gas and solids flowing through the injectors, such as by way of non-limiting example, shutting off some of the injection ports 356 which control the gas flows independently of the solids flows. Further, the plurality of injection ports 356 facilitates independently controlling the solids and gas flows into the interior cavity 360 such that if one of the radiant heating tubes 348 becomes non-operative, the injection ports 356 adjacent the tube may be shut off while permitting the rest of the injection ports 356 and radiant heating tubes 348 to function properly.

Those skilled in the art will recognize that using SiC pressurized from the outside for the radiant heating tubes 348 is advantageous because under failure SiC will crush, and not explode, thereby reducing potential damage to other SiC tubes within the interior cavity 360 of the refractory lined vessel 344. It will be recognized that in other reactor designs, the solids flow cannot be shut off to only a portion of the reactor. In the illustrated embodiment of FIGS. 3-1 to 3-2, however, if one of the radiant heating tubes 348 becomes damaged, the damaged tube can be shut off by stopping combustion gas flow without affecting the rest of the radiant heating tubes 348. Thus, in the event of damage to one of the radiant heating tubes 348, only one radiant tube's worth of production (˜100 lb/hr) is lost rather than at least 25× greater loss (˜2500 lb/hr) which would occur in other reactor designs.

The refractory lined vessel 344, the plurality of radiant heating tubes 348, and the plurality of injection ports 356 extending through the metal tube sheet 352 are configured to 1) gasify particles of biomass in a presence of steam (H2O) to produce a low CO2 synthesis gas that includes hydrogen, carbon monoxide gas and less than 15% CO2 by total volume generated in a gasification reaction of the particles of biomass, or 2) reform natural gas in a non-catalytic reformation reaction, using thermal energy from the radiant heating tubes 348 positioned in the interior cavity 360. Thus, in an embodiment, the plurality of injection ports 356 are configured to inject 1) the particles of biomass, or 2) the natural gas into the refractory lined vessel 344, and also are in fluid communication with a source of the steam.

A heat source is in thermal communication with the radiant heating tubes 348 to internally heat each tube and exchange heat through the walls of the tubes to an environment of the interior cavity 360 of the reactor vessel where 1) the particles biomass or natural gas is flowing to cause an operating temperature of between 900 degrees C. to 1600 degrees C. It will be recognized by those skilled in the art that the plurality of radiant heating tubes 348 and the refractory lined vessel 344 are configured to cooperate such that heat is radiantly transferred to 1) the particles of biomass, or 2) the natural gas passing between the radiant heating tubes 348 from the upper end 364 to the lower end 368 of the refractory lined vessel 344. The plurality of radiant heating tubes 348 coupled with the refractory lining of the vessel 344 provide enough energy for the 1) gasification reaction of the particles of biomass, or 2) non-catalytic reformation of the natural gas. It will be further recognized that the plurality of radiant heating tubes 348 and the refractory lined vessel 344 are configured to cooperate such that heat is radiantly transferred by primarily absorption and re-radiation, as well as secondarily through convection and conduction, to the reacting particles to drive the biomass gasification reaction or natural gas reformation reaction of reactants flowing between the radiant heating tubes 348 from the upper end 364 to the lower end 368 of the refractory lined vessel 344. Thus, the gasification reaction is driven primarily by radiant heat to produce the low CO2 synthesis gas. Moreover, the walls of the refractory lined vessel 344 are comprised of materials having low heat transfer rate characteristics and the plurality of radiant heating tubes 348 preferably are comprised of materials possessing high heat transfer rate characteristics, such that particles of biomass within the vessel 344 are heated to a temperature high enough for substantial tar destruction to less than 200 mg/m̂3 and preferably less than 50 mg/m̂3, and a gasification of greater than 80 percent of a carbon content of the particles of biomass into reaction products including hydrogen and carbon monoxide gas.

In an embodiment, an ash removal mechanism removes ash remnants and other particulates resulting from the reactions and end product gasses from the lower end 368 of the refractory lined vessel 344. In one embodiment, the ash removal mechanism comprises an internal, integral quench zone located between a bottom of the plurality of radiant heating tubes 348 and the lower end 368 of the refractory lined vessel 344. In an embodiment, the quench zone cools the reaction products to a temperature at which ash and other particulates can be removed, thereby facilitating a downstream heat recovery from the end product gasses. In another embodiment, the quench zone is located downstream of the refractory lined vessel 344, and the ash remnants are removed from the lower end 368 of the refractory lined vessel 344 prior to the quench occurring. In some embodiments, the quenching may be comprised of direct water injection, gas injection, methanol injection, or a mixture of both. Those skilled in the art will recognize that the integral quench advantageously facilitates working with solids having a lower temperature than when the quench is located downstream of the vessel 344.

In some embodiments, the refractory lined vessel 344 includes an ash removal mechanism comprising one or more outlet ports for removing solids and gases from the interior cavity 360 of the vessel. In an embodiment, the refractory lined vessel 344 includes one outlet port for removal of ash remnants and gas byproducts, including the product syngas. In the illustrated embodiment of FIG. 3-1, the lower end 368 of the refractory lined vessel 344 comprises a solids outlet port 372 and a gas byproducts port 376. The solids outlet port 372 is provided for removing ash remnants and any other particulates that fall out of the gas byproducts stream as the commingled stream is directed to the lower end 368 of the refractory lined vessel 344. In an embodiment, a region 380 adjacent to the solids outlet port 372 is contoured to direct the ash remnants and particulates toward the solids outlet port 372. The region 380 may be either tapered or concave so as to direct the ash remnants and particulates toward the solids outlet port 372 at an apex of the lower end 368 of the refractory lined vessel 344. In an embodiment, the solids outlet port 372 cooperates with a moving collection bed at the bottom of the refractory lined vessel 344 for the ash removal. In an exemplary embodiment, a single solids outlet port and integral quench has an off-take of between 30,000 lb/hr and greater than 50,000 lb/hr.

The gas byproducts outlet port 376 is located in a higher position of the refractory lined vessel 344 than the solids outlet port 372, such that gas byproducts, including product syngas, are removed from the interior cavity 360 without drawing the ash remnants and other particulates into the gas byproducts outlet 376. Preferably, the gas byproducts outlet 376 conveys the gas byproducts and syngas to an external quench unit. In an embodiment, the gas byproducts outlet port 376 may further comprise a diagonally angled baffle above the gas byproducts outlet port 376 configured to direct ash remnants and particulates to the lower end 368 of the refractory lined vessel 344, thereby preventing the gas byproducts from migrating back up into the radiant heating tube 348 area of the refractory lined vessel 344.

In an embodiment, the radiant heat-driven refractory lined vessel 344 and the radiant heating tubes 348 are configured in a recuperative configuration, where 1) the biomass particles react in a decomposition reaction to produce syngas and other product gases, or 2) the natural gas undergoes a steam reformation reaction. Both reactions potentially leave a small amount of carbon black on the walls of the refractory lined vessel 344 and the radiant heating tubes 348. After operating in a “syngas production” mode and having the biomass particles and/or natural gas supplied for a period of time, the refractory lined vessel 344 may then be shifted into a “cleanup” mode during which a number of chemical agents, such as steam, carbon dioxide gas, or other suitable gases, are supplied to the interior cavity 360 so as to remove the carbon black from the walls of the refractory lined vessel 344 and the radiant heating tubes 348. In some embodiments, one or more gases resulting from the removal of the carbon black from the walls of the refractory lined vessel 344 and the radiant heating tubes 348 may be supplied to another process in the system, such as processes occurring in a downstream methanol synthesis plant.

It should be understood that the exemplary embodiment of the radiant heat-driven chemical reactor 340 illustrated in FIGS. 3-1 to 3-2 significantly reduces the number of required biomass feed points (i.e., the number of injection ports 356). For example, the radiant heat-driven chemical reactor 340 used in a 15,000 BPD chemical plant reduces the number of required biomass feed points from about 1500 to 10-200. Moreover, those skilled in the art will recognize that because the total power of the radiant heat-driven chemical reactor 340 is proportional to the surface area of the radiant heating tubes 348, and the total number of radiant heating tubes 348 that are packable into the refractory lined vessel 344 is proportional to the volume of the internal cavity 360, the chemical reactor 340 advantageously has a volumetric gasifier capacity scaling relationship as opposed to being surface area dependent as is the case with some conventional chemical reactors.

FIG. 1 illustrates a flow schematic of an embodiment of a steam explosion unit having an input cavity to receive biomass as a feedstock, two or more steam supply inputs, and two or more stages to pre-treat the biomass for subsequent supply to a biomass gasifier.

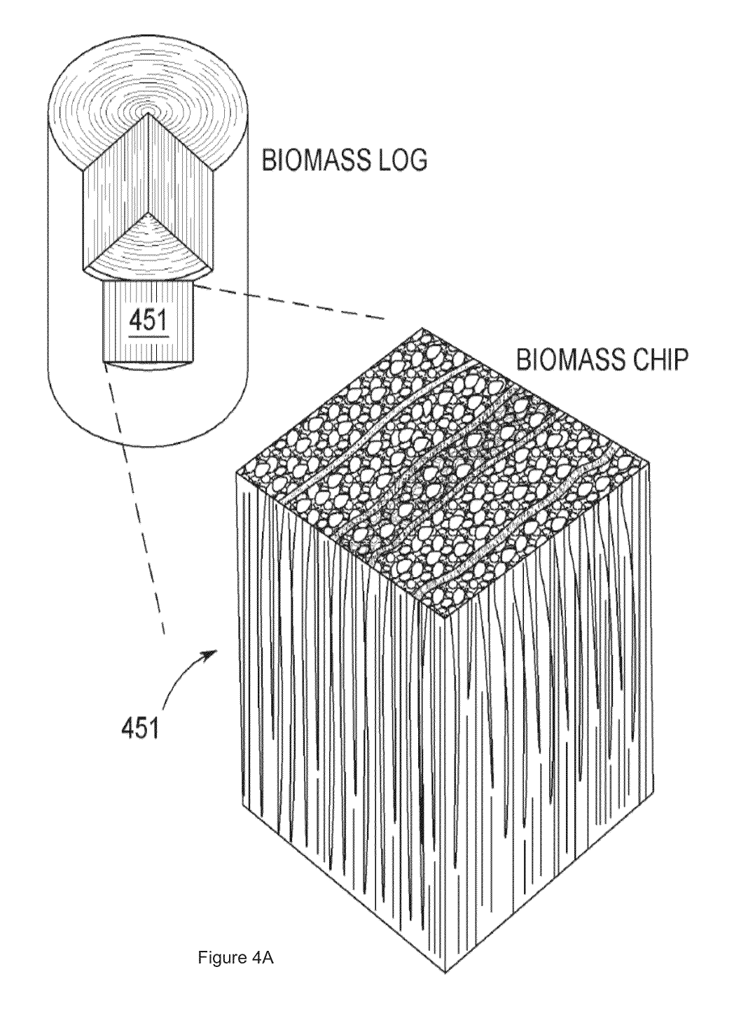

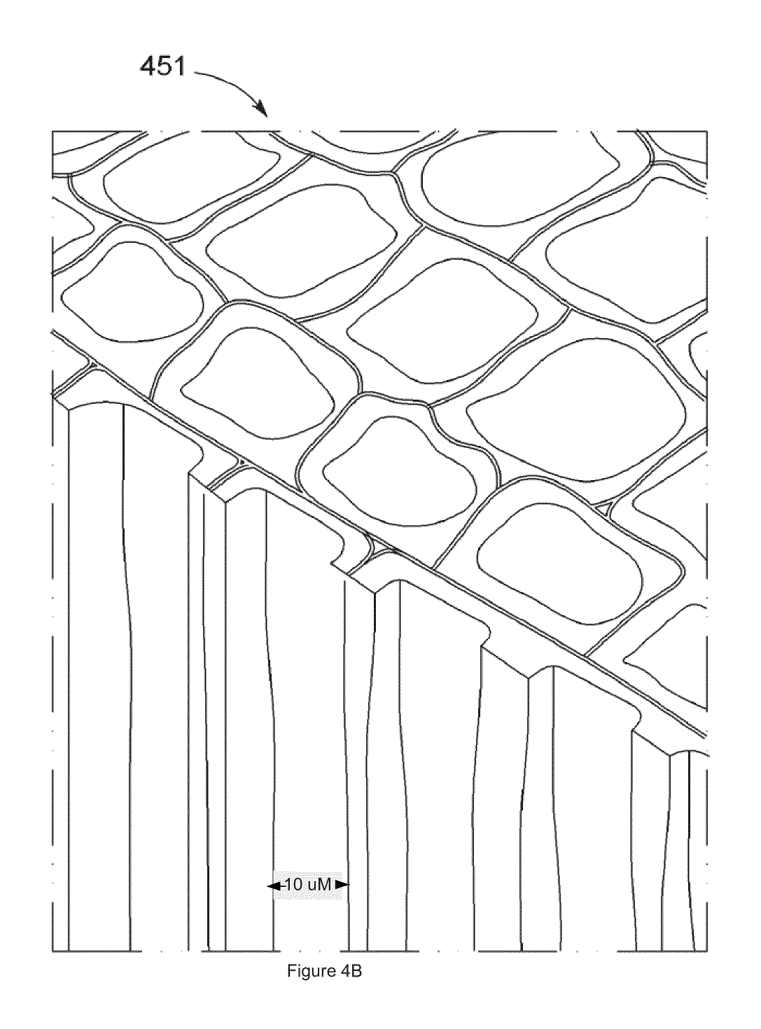

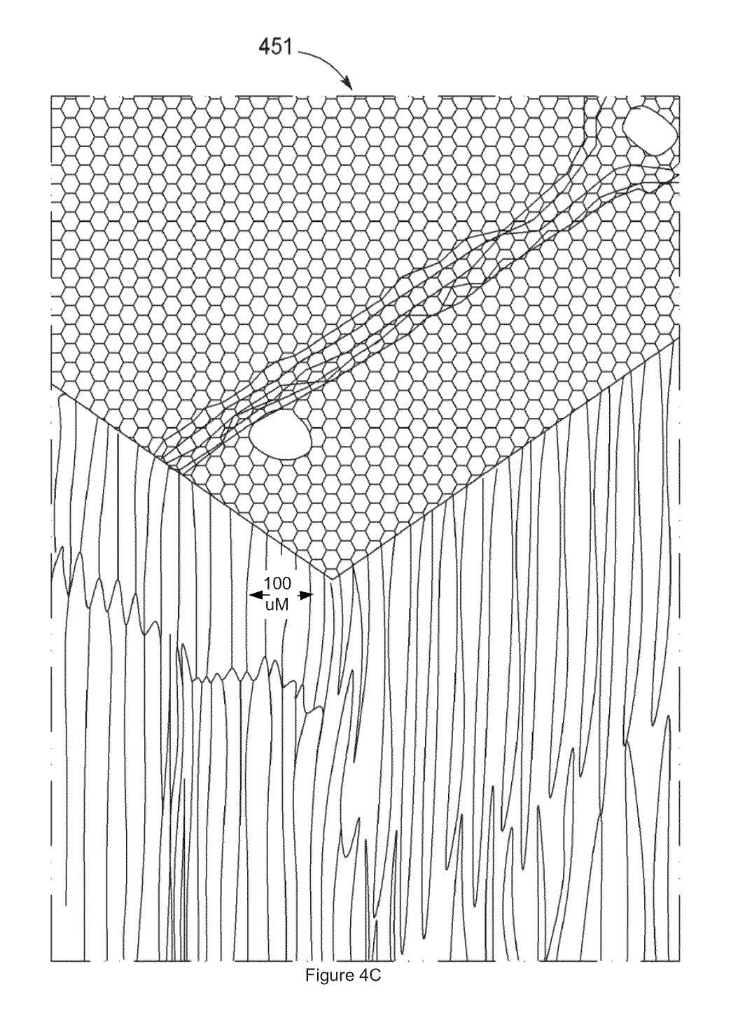

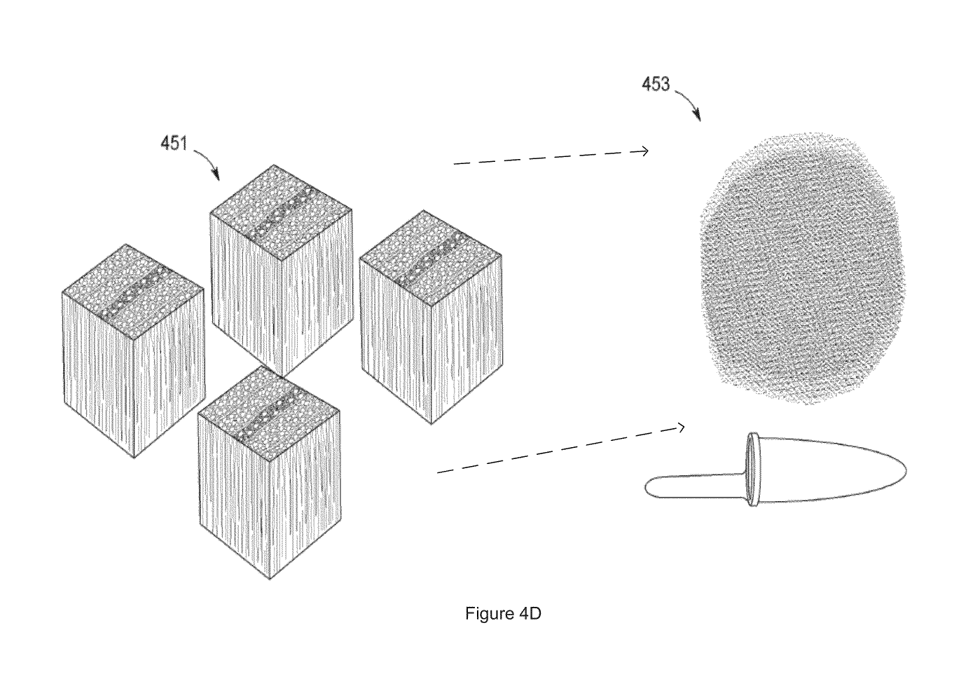

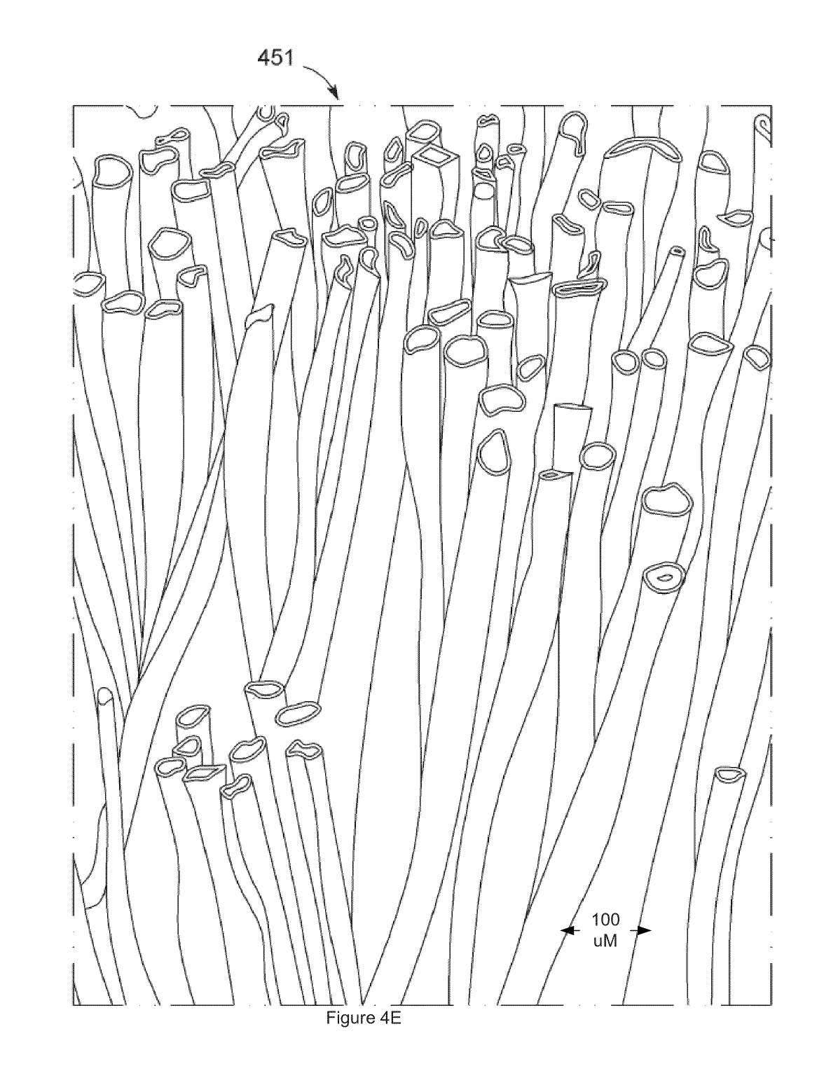

Moisture values in the incoming biomass in chip form can vary from about 15% to 60% for biomass left outside without extra drying. Chips of biomass may be generated by a chipper unit 104 cooperating with some filters with dimensions to create chips of less than about one inch and on average about 0.5 inches in average length and a ¼ inch in thickness on average. (See for example FIG. 4a illustrating a chip of biomass 451 from a log of biomass 453) The biomass chipper unit 104 may contain four or more blades used to chop and chip the biomass. The feed speed of the logs of biomass, the speed of the knife blades, the protrusion distance of the knives and the angle of the knives, can all act to control the chip size. The chips are then screened and those that are oversized may be re-chipped. There may be a blending of chips from different sources or timber species to enhance certain properties. A magnet or other scanner may be passed over to detect and remove impurities. Chips of biomass are fed on a conveyor or potentially placed in a pressure vessel in the thermally decomposing stage in the steam explosion unit 108 that starts a decomposition, hydrating/moistening, and softening of the chips of biomass using initially low-pressure saturated steam. The low-pressure saturated steam may be at 100 degrees C. The system may also inject some flow aids at this point, such as recycled ash from the biomass gasifier 114, to prevent clogs and plugging by the biomass chips.

The chipper unit 104 may feed to and the steam explosion unit 108 is configured to receive two or more types of biomass feedstocks, where the different types of biomass include 1) soft woods, 2) hard woods, 3) grasses, 4) plant hulls, and 5) any combination that are blended and steam explosion processed into a homogenized torrefied feedstock within the steam explosion unit 108 that is subsequently collected and then fed into the biomass gasifier 114. The steam explosion unit 108, flash dryer 112, and biomass gasifier 114 are designed to be feedstock flexible without changing out the physical design of the feed supply equipment or the physical design of the biomass gasifier 114 via at least particle size control of the biomass particles produced from steam explosion stage and flash dryer 112.

As discussed, a magnetic filter and an air cleaning filter system may couple to the thermal hydrating stage to ensure that metal fragments and heavy rocks are removed from the biomass in chip form prior to entering the thermal hydrating stage. The magnetic filter and the air cleaning filter system prevent any metal fragments and/or heavy rocks from plugging portions of the steam explosion unit including the discharge outlet. The air cleaning filter system assists in dropping out really heavy rocks as well as light weight sand. Note, the orifice forming the discharge outlet of the steam explosion stage may be, for example, 0.25 to 0.375 of an inch.

The steam explosion unit 108 has an input cavity to receive biomass as a feedstock, one or more steam supply inputs, and two or more stages to pre-treat the biomass for subsequent supply to a biomass gasifier 114. The stages use a combination of heat, pressure, and moisture that are applied to the biomass to make the biomass into a moist fine particle form. The steam explosion process breaks down a bulk structure of the received biomass, at least in part, by applying steam from a low pressure steam supply input to begin degrading bonds between lignin and hemi-cellulose from cellulose fibers of the biomass and increase a moisture content of the received biomass. (See for example FIG. 4B illustrating a chip of biomass having a fiber bundle of cellulose fibers surrounded and bonded together by lignin.) In the last stage, steam at least fourteen times atmospheric pressure from a high pressure steam supply input is applied to heat and pressurize any gases and fluids present inside the biomass to internally blow apart the bulk structure of the received biomass via a rapid depressurization of the biomass with the increased moisture content and degraded bonds.

In an embodiment, the two or more stages of the steam explosion unit 108 include at least a thermally hydrating stage and a steam explosion stage.

The thermally hydrating stage has the input cavity to receive chips of the biomass and the low pressure steam supply input to apply low-pressure saturated steam into a vessel containing the chips of biomass. The thermally hydrating stage is configured to receive the biomass in chip form including leaves, needles, bark, and wood. The thermally hydrating stage applies the low-pressure steam to the biomass at a temperature above a glass transition point of the lignin in order to soften and elevate the moisture content of the biomass so the cellulose fibers of the biomass in the steam explosion stage can easily be internally blown apart from the biomass in chip form. In an embodiment, the chips of biomass are heated to greater than 60° C. using the steam. The low pressure steam supply input applies low-pressure saturated steam into a vessel containing the chips of biomass at an elevated temperature of above 60 degrees C. but less than 145 degrees C. at a pressure around atmospheric PSI, to start a decomposition, hydrating, and softening of the received biomass in chip form. The low pressure supply input may consist of several nozzles strategically placed around the vessel. A set of temperature sensors provides feedback on the elevated temperature of the received chips of biomass. A control system is configured to keep the chips of biomass to stay for a residence time of 8 to 20 minutes in the thermally hydrating stage, which is long enough to saturate the chips of biomass with moisture before moving out the biomass to the steam explosion stage.

The thermally hydrating stage, potentially via a screw feed system, feeds chips of biomass that have been softened and have increased in moisture content to the steam explosion stage. A control system maintains a pressure of the steam explosion stage to be 10 to 30 times greater than the pressure that is present in the thermally hydrating stage and at an elevated temperature, such as a temperature of 160-270° C., 200-210° C. preferably. The pressure may be at 180-450 Pound per Square Inch (PSI) (256 PSI preferably). The steam explosion stage further raises the moisture content of the biomass to at least 40% by weight and preferably 50 to 60% moisture content by weight. The % moisture by weight may be the weight of water divided by a total weight consisting of the chips of biomass plus a water weight. In the steam explosion stage, the softened and hydrated chips of biomass are exposed to high temperature and high-pressure steam for a sufficient time period, such as 3 minutes to 15 minutes, to create high pressure steam inside the partially hollow cellulose fibers and other porous areas in the bulk structure of the biomass material. (See for example FIG. 4C illustrating a chip of biomass having a fiber bundle of cellulose fibers surrounded and bonded together by lignin but under magnification having numerous porous areas.)

After the thermally hydrating stage, the softened biomass in chip form are any combination of 1) crushed and 2) compressed into a plug form, which is then fed into a continuous screw conveyor system. The continuous screw conveyor system moves the biomass in plug form into the steam explosion stage. The continuous screw conveyor system uses the biomass in plug form to prevent blow back backpressure from the high-pressure steam present in the steam explosion stage from affecting the thermally hydrating stage. Other methods could be used such as 1) check valves and 2) moving biomass in stages where each stage is isolatable by an opening and closing mechanism.

The steam explosion stage can operate at pressures up to 850 PSI but stays preferably below 450 PSI. A set of sensors may detect the operating pressure. The plug screw feeder conveys the chips along the steam explosion stage. High-pressure steam is introduced into the plug screw feeder in a section called the steam mixing conveyor. The high pressure supply input may consist of several nozzles strategically placed around the steam mixing conveyor. Retention time of the biomass chip material through the steam explosion stage is accurately controlled via the plug screw feeder. In the steam explosion stage, the biomass in plug form is exposed to high temperature and high pressure steam at least 160 degrees C. and 160 PSI from the high pressure steam input for at least 5 minutes and preferably around 10 minutes until moisture penetrates porous portions of the bulk structure of the biomass and all of the liquids and gases in the biomass are raised to the high pressure.

The continuous screw conveyor system feeds the biomass in plug form through the steam explosion stage to a refiner stage. The steam explosion stage may couple to a refiner stage that has one or more blades configured to mechanically agitate the pressurized biomass prior to the pressurized biomass exiting the steam explosion stage through the exit orifice to a blow line maintained at a pressure of less than a third of the pressure inside the steam explosion stage in order to internally blow apart the pressurized biomass. The mechanical agitation in the refiner stage is configured to cause resulting biomass in particle form to have a more consistent size distribution of the average dimensions of the biomass particles. The blades of the refiner stage mechanically agitate the pressurized and moistened biomass and send the agitated biomass to the orifice exit.

In an embodiment, a small opening forms the exit and goes into a tube or other container area that is maintained at around 2-10 bar of pressure and any internal fluids or gases at the high pressure expand to internally blow apart the biomass. In some cases, the pressure drop is from the high pressure in the Steam Explosion Reactor all the way down to atmospheric pressure. In either case, the large pressure drop occurring in the tube or other container between the exit in the steam explosion stage and a cyclone water removal stage is dropped rapidly. In an embodiment, the pressure drop occurs rapidly by extruding the bulk structure of the biomass at between 160 to 450 PSI into a tube at the dramatically reduced pressure, such as 4-10 bar, to cause an internal “explosion” rapid expansion of steam upon the drop in pressure or due to the “flashing” of liquid water to vapor upon the drop in pressure below its vapor pressure, which internally blows apart the biomass in chip form into minute fine particles of biomass. In another embodiment, the steam explosion reactor portion of the steam explosion stage contains a specialized discharge mechanism configured to “explode” the biomass chip material to a next stage at atmospheric pressure. The discharge mechanism opens to push the biomass from the high-pressure steam explosion reactor out of this reactor discharge outlet valve or door into the feed line of the blow tank.

Thus, the pressurized steam or super-heated water from the steam explosion reactor in this stage is then dropped rapidly to cause an explosion, which disintegrates the chips of biomass into minute fine particles. (See for example FIG. 4D illustrating chips of biomass exploded into fine particles of biomass 453.) The original bundle of fibers making up the biomass is exploded into fragments making discrete particles of fine powder. (See for example FIGS. 4A-C illustrating different levels of magnification of a chip of biomass having a fiber bundle of cellulose fibers surrounded and bonded together by lignin and compare to FIG. 4D.)

The moisture and biomass chips get extruded out the reactor discharge to a container, such as the blow line, at approximately atmospheric pressure. The high-pressure steam or water conversion to vapor inside the partially hollow fibers and other porous areas of the biomass material causes the biomass cell to explode into fine particles of moist powder. The bulk structure of the biomass includes organic polymers of lignin and hemi-cellulose that surrounds a plurality of cellulose fibers. The bulk structure of the biomass is internally blown apart in this SEP step that uses at least moisture, pressure, and heat to liberate and expose the cellulose fibers to be able, as an example, to directly react during the biomass gasification reaction rather than react only after the layers of lignin and hemi-cellulose have first reacted to then expose the cellulose fibers. The high temperature also lowers the energy/force required to breakdown the biomass' structure as there is a softening of lignin that facilitates fiber separation along the middle lamella.

The biomass produced into the moist fine particle form from the stages has average dimensions of less than 50 microns thick and less than 500 microns in length. As discussed, the steam explosion stage may couple to a refiner stage that has one or more blades configured to mechanically agitate the pressurized biomass prior to the pressurized biomass exiting the steam explosion stage through the exit orifice to a blow line. The produced fine particles of biomass with reduced moisture content includes cellulose fibers that are fragmented, torn, shredded and any combination of these and may generally have an average dimension of less than 30 microns thick and less than 250 microns in length. Those produced moist fine particles of biomass are subsequently fed to a feed section of the biomass gasifier 114.

Internally blowing apart the bulk structure of biomass in a fiber bundle into pieces and fragments of cellulose fiber, lignin and hemi-cellulose results in all three 1) an increase of a surface area of the biomass in fine particle form compared to the received biomass in chip form, 2) an elimination of a need to react outer layers of lignin and hemi-cellulose prior to starting a reaction of the cellulose fibers, and 3) a change in viscosity of the biomass in fine particle form to flow like grains of sand rather than like fibers.

The morphological changes to the biomass coming out of SEP reactor can include:
a. No intact fiber structure exists rather all parts are exploded causing more surface area, which leads to higher reaction rates in the biomass gasifier;
b. Fibers appear to buckle, they delaminate, and cell wall is exposed and cracked;
c. Some lignin remains clinging to the cell wall of the cellulose fibers;
d. Hemi-cellulose is partially hydrolyzed and along with lignin are partially solubilized;
e. The bond between lignin and carbohydrates/polysaccharides (i.e. hemi-cellulose and cellulose) is mostly cleaved; and
f. many other changes discussed herein.

The created moist fine particles may be, for example, 20-50 microns thick in diameter and less than 100 microns in length on average. Note, 1 inch=25,400 microns. Thus, the biomass comes from the chipper unit 104 as chips up to 1 inch in length and 0.25 inches in thickness on average and go out as moist fine particles of 20-50 microns thick in diameter and less than 100 microns in length on average, which is a reduction of over 2000 times in size. The violent explosive decompression of the saturated biomass chips occurs at a rate swifter than that at which the saturated high-pressure moisture in the porous areas of the biomass in chip form can escape from the structure of biomass.

Note, no external mechanical separation of cells or fiber bundles is needed, rather the process uses steam to explode cells from inside outward. (See FIG. 4E illustrating a chip of biomass a chip of biomass 451 having a bundle of fibers that are frayed or partially separated into individual fibers.) Use of SEP on the biomass chips produces small fine particles of cellulose and hemi-cellulose with some lignin coating. (See FIG. 4D illustrating example chips of biomass, including a first chip of biomass 451, exploded into fine particles of biomass 453.) This composite of lignin, hemi-cellulose, and cellulose in fine form has a high surface area that can be moved/conveyed in the system in a high density.

The produced fine particles of biomass are fed downstream to the biomass gasifier 114 for the rapid biomass gasification reaction in a reactor of the biomass gasifier 114 because they create a higher surface to volume ratio for the same amount of biomass compared to the received biomass in chip form, which allows a higher heat transfer to the biomass material and a more rapid thermal decomposition and gasification of all the molecules in the biomass.

As discussed, at an exit of the steam explosion stage, the biomass in plug form explodes into the moist fine particles form. The steam explosion stage filled with high-pressure steam and/or superheated water contains a discharge outlet configured to “explode” the biomass material to a next stage at atmospheric pressure to produce biomass in fine particle form. The biomass in fine particle form flows through a feed line of a blow tank at high velocity.

The biomass in moist fine particle form enters the feed line of the blow tank. The produced particles of biomass loses a large percentage of the moisture content due to steam flashing in the blow line and being vented off as water vapor. The produced particles of biomass and moisture are then separated by a cyclone filter and then fed into a blow tank. Thus, a water separation unit is in-line with the blow line. A collection chamber at an outlet stage of the steam explosion stage is used to collect the biomass reduced into smaller particle sizes in pulp form and is fed to the water separation unit. Water is removed from the biomass in fine particle form in a cyclone unit and/or a dryer unit.

A moisture content of the fine particles of biomass is further dried out at an exit of the blow tank by a dryer unit such as a flash dryer or low temperature torrefaction unit that reduces the moisture content of fine particles of biomass to 0-20% by weight preferably. A goal of the fiber preparation is to create particles of biomass with maximum surface area and as dry as feasible to 5-20% moisture by weight of the outputted biomass fine particle. The flash dryer merely blows hot air to dry the biomass particles coming out from the blow tank. The flash dryer can be generally located at the outlet of the blow tank or replace the cyclone at its entrance to make the outputted biomass particles contain a greater than 5% but less than 20% moisture content by weight. The flash dryer may feed the biomass to a silo for storage to further dry out the SEP fine particles of biomass prior to being fed into a lock hopper. In an embodiment, a paddle flash dryer type can reduce the biomass particle size further due to the velocity of the gas carrying the particles going into the dryer it acts as a mill on the incoming particles of biomass.

The resulting particles of biomass differs from Thermal Mechanical Pulping (TMP) in that particles act more like crystal structures and flows easier than fibers which tend to entangle and clump. The particles also decompose more readily than fibers from a TMP process.

The fine particles of biomass out of the blow tank and flash dryer has a low moisture content. A silo may be used to further reduce the moisture of the particles if needed. The biomass gasifier 114 has a reactor vessel configured to react the biomass in moist fine particle form with an increased surface area due to being blown apart by the steam explosion unit 108. The biomass gasifier 114 has a high pressure steam supply input and one or more heaters, and in the presence of the steam the biomass in fine particle form are reacted in the reactor vessel in a rapid biomass gasification reaction between 0.1 and 40.0 second resident time to produce at least syngas components, including hydrogen (H2) and carbon monoxide (CO). When the fine particles produced are supplied in high density to the biomass gasifier 114, then the small particles react rapidly and decompose the larger hydrocarbon molecules of biomass into the syngas components more readily and completely. Thus, nearly all of the biomass material lignin, cellulose fiber, and hemi-cellulose completely gasify rather than some of the inner portions of the chip not decomposing to the same extent to that the crusted shell of a char chip decomposes. These fine particles compared to chips create less residual tar, less carbon coating and less precipitates. Thus, breaking up the integrated structure of the biomass in a fiber bundle tends to decrease an amount of tar produced later in the biomass gasification. These fine particles also allow a greater packing density of material to be fed into the biomass gasifier 114. As a side note, having water as a liquid or vapor present at least 10 percent by weight may assist in generating methanol CH3OH as a reaction product in addition to the CO and H2 produced in the biomass gasifier 114.

The torrefaction unit and biomass gasifier 114 may be combined as an integral unit.

In an embodiment, the biomass gasifier 114 is designed to radiantly transfer heat to particles of biomass flowing through the reactor design with a rapid gasification residence time, of the biomass particles of 0.1 to 30 seconds and preferably less one second. The biomass particles and reactant gas flowing through the radiant heat reactor primarily are driven from radiant heat from the surfaces of the radiant heat reactor and potentially heat transfer aid particles entrained in the flow. The reactor may heat the particles in a temperature in excess of generally 900 degrees C. and preferably at least 1200° C. to produce the syngas components including carbon monoxide and hydrogen, as well as keep produced methane at a level of ≦1% of the compositional makeup of exit products, minimal tars remaining in the exit products, and resulting ash.

FIGS. 3-1 to 3-4 illustrate exemplary embodiments of the biomass gasifier 114. FIGS. 3-1 and 3-2 illustrate the radiant heat-driven chemical reactor 340 discussed above in detail. FIG. 3-3 illustrates a fountain reactor using radiant heat in which entrainment gases carrying biomass enter at the bottom of the gasifier and are projected through a center tube and fountain over a separation wall created by the center tube and fall in a section created between an outer tube and the center tube. FIG. 3-4 illustrates an exemplary downdraft radiant heat reactor in which multiple tubes are used to provide radiant heat to the reactor. The biomass may either be external to the tubes, while heat is supplied internal to the tubes, or visa-versa.

Any of the gasifiers illustrated in FIGS. 3-1 to 3-4 may be used to conduct various chemical reactions including one or more of 1) the biomass gasification (CxHyOz+(x−z)H2O−>xCO+(y/2+(x−z))H2) with the particles of biomass from the steam explosion process, 2) hydrocarbon reforming or cracking, including, but not limited to, steam methane reforming (CH4+H2O−>3H2+CO), steam ethane cracking (C2H6−>C2H4+H2), and steam carbon gasification (C+H2O−>CO+H2), and 3) natural gas reformation reactions. The indirect radiation driven geometry of the radiant heat chemical reactor uses radiation as a primary mode of heat transfer to the heat-transfer-aid particles, the reactant gas and any biomass particles entrained with the heat-transfer-aid particles. The radiant tube gasifier design may also used to conduct non-catalytic reforming of natural gas.

The thermal receiver has a cavity with an inner wall. The radiation driven geometry of the cavity wall of the thermal receiver relative to the reactor tubes locates the multiple tubes of the chemical reactor inside the receiver. A surface area of the cavity walls is greater than an area occupied by the reactor tubes to allow radiation to reach areas on the tubes from multiple angles. The inner wall of the receiver cavity and the reactor tubes exchange energy primarily by radiation, with the walls and tubes acting as re-emitters of radiation to achieve a high radiative heat flux reaching all of the tubes, and thus, avoid shielding and blocking the radiation from reaching the tubes, allowing for the reactor tubes to achieve a fairly uniform temperature profile from the start to the end of the reaction zone in the reactor tubes.

Thus, the geometry of the reactor tubes and cavity wall shapes a distribution of incident radiation with these 1) tubes that are combined with 2) a large diameter cavity wall compared to an area occupied by the enclosed tubes, and additionally 3) combined with an inter-tube radiation exchange between the multiple reactor tube geometric arrangement relative to each other with the geometry. The wall may be made of material that highly reflects radiation or absorbs and re-emits the radiation. The shaping of the distribution of the incident radiation uses both reflection and absorption of radiation within the cavity of the receiver. Accordingly, the inner wall of the thermal receiver is aligned to and acts as a radiation distributor by either 1) absorbing and re-emitting radiant energy, 2) highly reflecting the incident radiation to the tubes, or 3) any combination of these, to maintain an operational temperature of the enclosed ultra-high heat flux chemical reactor. The radiation from the 1) cavity walls, 2) directly from the gas fired burners, and 3) from an outside wall of other tubes acting as re-emitters of radiation is absorbed by the reactor tubes, and then the heat is transferred by conduction to the inner wall of the reactor tubes where the heat radiates to the reacting particles and gases at temperatures between 900 degrees C. and 1600 degrees C., and preferably above 1100 degrees C.

As discussed, the inner wall of the cavity of the receiver and the reactor tubes exchange energy between each other primarily by radiation, not by convection or conduction, allowing for the reactor tubes to achieve a fairly uniform temperature profile even though generally lower temperature biomass particles and entrainment gas enter the reactor tubes in the reaction zone from a first entrance point and traverse through the heated cavity to exit the reaction zone at a second exit point. This radiation heat transfer from the inner wall and the reactor tubes drives the chemical reaction and causes the temperature of the chemical reactants to rapidly rise to close to the temperature of the products and other effluent materials departing from the exit of the reactor.

A rapid gasification of biomass particulates with a resultant stable ash formation occurs within a residence time within the reaction zone in the reactor tubes, resulting in a complete amelioration of tar to less than 500 milligrams per normal cubic meter, and at least a 80% conversion of the biomass into the production of the hydrogen and carbon monoxide products.

To achieve high conversion and selectivity, biomass gasification requires temperatures in excess of 1000° C. These are difficult to achieve in standard fluidized bed gasifiers, because higher temperatures require combustion of an ever larger portion of the biomass itself. As a result, indirect and fluidized bed gasification is typically limited to temperatures of 800° C. At these temperatures <800° C., production of unwanted higher hydrocarbons (tars) is significant. These tars clog up downstream equipment and foul/deactivate catalyst surfaces, requiring significant capital investment (10-30% of total plant cost) in tar removal equipment. High heat flux thermal systems are able to achieve high temperatures very efficiently. More importantly, the efficiency of the process can be controlled as a function of concentration and desired temperature, and is no longer linked to the fraction of biomass lost to achieving high temperature. As a result, temperatures in the tar cracking regime (1000-1300° C.) can be achieved without any loss of fuel yield from the biomass or overall process efficiency. This removes the complex train of tar cracking equipment typically associated with a biomass gasification system. Additionally, operation at high temperatures improves heat transfer and decreases required residence time, decreasing the size of the chemical reactor and its capital cost.

The temperatures of operation, clearly delineated with wall temperatures between 1200° C. and 1450° C. and exit gas temperatures in excess of 900° C. but not above silica melting temperatures (1600° C.) is not typically seen in gasification, and certainly not seen in indirect (circulating fluidized bed) gasification. The potential to do co-gasification of biomass and steam reforming of natural gas, which can be done in the ultra-high heat flux chemical reactor, could not be done in a partial oxidation gasifier (as the methane would preferentially burn). The process' feedstock flexibility derives from the simple tubular design, and most gasifiers, for reasons discussed herein, cannot handle a diverse range of fuels.

A material making up the inner wall of the receiver cavity may have mechanical and chemical properties to retain its structural strength at high temperatures between 1100-1600° C., have very high emissivity of ε>0.8 or high reflectivity of ε<0.2, as well as high heat capacity (>200 J/kg-K), and low thermal conductivity (<1 W/m-K) for the receiver cavity. A material making up the reactor tubes possesses high emissivity (ε>0.8), high thermal conductivity (>1 W/m-K), moderate to high heat capacity (>150 J/kg-K).

FIG. 2 illustrates a flow diagram of an integrated plant to generate syngas from biomass and generate a liquid fuel product from the syngas. The steam explosion unit 308 may have a steam explosion stage and thermally hydrating stage that supplies particles of biomass to either a flash dryer, a torrefaction unit, or directly to the biomass gasifier 314.

A conveying system coupled to a collection chamber at the outlet stage of the steam explosion unit 308 and cyclones supplies biomass in particle form to either a torrefaction unit, or directly to the biomass gasifier 314, or to a flash dryer. A majority of the initial lignin and cellulose making up the biomass in the receiver section of the steam tube stage in the steam explosion unit 308 remains in the produced particles of biomass but now is substantially separated from the cellulose fibers in the collection chamber at the outlet stage of the steam explosion stage 308.

The collection chamber in the steam explosion unit 308 is configured to collect non-condensable hydrocarbons from any off gases produced from the biomass during the steam explosion process.

After the steam explosion stage 308, water is removed from the biomass in a water separation unit, for example a cyclone unit, and the reduced moisture content biomass made of loose fibers and separated lignin and cellulose may be fed to a dryer.

In an embodiment, the reduced moisture content pulp may go directly from the steam explosion unit 308 to the biomass gasifier 314, a torrefaction unit 312, or to a dryer. Generally, the particles of biomass go to the biomass gasifier 314. Note, the torrefaction unit 312 and biomass gasifier may be combined into a single unit.

The biomass gasifier 314 has a reactor configured to react particles of the biomass broken down by the two or more stages of the steam explosion unit 308 and those biomass particles are subsequently fed to a feed section of the biomass gasifier 314. The biomass gasifier 314 has a high temperature steam supply input and one or more heaters and in the presence of the steam the particles of the biomass broken down by the steam explosion unit 308 are reacted in the reactor vessel in a rapid biomass gasification reaction at a temperature of greater than 700 degrees C. in less than a five second residence time in the biomass gasifier 314 to create syngas components, including hydrogen (H2) and carbon monoxide (CO), which are fed to a methanol (CH3OH) synthesis reactor 310. In the gasifier 314, the heat transferred to the biomass particles made up of loose or fragments of cellulose fibers, lignin, and hemicellulose no longer needs to penetrate the layers of lignin and hemicellulose to reach the fibers. In some embodiments, the rapid biomass gasification reaction occurs at a temperature of greater than 700 degrees C. to ensure the removal tars from forming during the gasification reaction. Thus, a starting temperature of 700 degrees but less than 950 degrees is potentially a significant range of operation for the biomass gasifier. All of the biomass gasifies more thoroughly and readily.

The biomass gasifier 314 may have a radiant heat transfer to the particles of biomass and reactant gas flowing through the reactor design with a rapid gasification residence time of 0.1 to 60 seconds, and preferably less than 10 seconds. Primarily radiant heat from the surfaces of the radiant heat reactor and particles entrained in the flow heat the particles and resulting gases to a temperature in excess of generally 700 degrees C., and preferably at least 1200° C., to produce the syngas components including carbon monoxide and hydrogen, as well as keep produced methane at a level of ≦1% of the compositional makeup of exit products, minimal tars remaining in the exit products, and resulting ash. In some embodiments, the temperature range for biomass gasification is greater than 800 degrees C. to 1400 degrees C.

Referring to FIG. 2, the plant may generate syngas for methanol production. Syngas may be a mixture of carbon monoxide and hydrogen that can be converted into a large number of organic compounds that are useful as chemical feed stocks, fuels and solvents. For example, the biomass gasifier 314 gasifies biomass at high enough temperatures to eliminate a need for a catalyst to generate hydrogen and carbon monoxide for methanol production.

Biomass gasification is used to decompose the complex hydrocarbons of biomass into simpler gaseous molecules, primarily hydrogen, carbon monoxide, and carbon dioxide. Some mineral ash and tars can also be formed, along with methane, ethane, water, and other constituents. The mixture of raw product gases vary according to the types of biomass feedstock used and gasification processes used.

The biomass gasifier is followed by a gas clean up section to clean ash, sulfur, water, and other contaminants from the syngas gas stream exiting the biomass gasifier 314. The syngas is then compressed to the proper pressure needed for methanol synthesis. Additional syngas from steam methane reformer 327 may connect upstream or downstream of the compression stage.

The synthesis gases of H2 and CO from the gasifier and the steam methane reformer 327 are sent to the common input to the one or more methanol synthesis reactors. The exact ratio of hydrogen to carbon monoxide can be optimized by a control system receiving analysis from monitoring equipment on the compositions of syngas exiting the biomass gasifier 314 and the steam methane reformer 327, and causes the optimization of the ratio for methanol synthesis. The methanol produced by the one or more methanol synthesis reactors is then processed in a methanol to gasoline process.

The liquid fuel produced in the integrated plant may be gasoline or another such as diesel, jet fuel, or some alcohols.

Thus, both the biomass gasifier 314 and the SMR 327 can supply syngas components to the downstream organic liquid product synthesis reactor, such as methanol synthesis reactor 310. The methanol is then supplied to a methanol to gasoline process to create a high quality and high octane gasoline. The methanol may also be supplied to other liquefied fuel processes including jet fuel, DME, gasoline, diesel, and mixed alcohol.

FIGS. 4A-C illustrate different levels of magnification of an example chip of biomass 451 having a fiber bundle of cellulose fibers surrounded and bonded together by lignin.

FIG. 4D illustrates example chips of biomass, including a first chip of biomass 451, exploded into fine particles of biomass 453.

FIG. 4E illustrates a chip of biomass 451 having a bundle of fibers that are frayed or partially separated into individual fibers.

The radiant heat chemical reactor may be configured to generate chemical products including synthesis gas products. The multiple shell radiant heat chemical reactor may include a refractory vessel having an annulus shaped cavity with an inner wall. The radiant heat chemical reactor may have two or more reactor tubes made out of a solid material. The one or more reactor tubes are located inside the cavity of the refractory lined vessel.

An exothermic heat source, such as regenerative burners or gas fired burners may couple to the chemical reactor.

One or more feed lines supply biomass and reactant gas into the bottom portion of the chemical reactor. The feed lines are configured to supply chemical reactants including 1) biomass particles, 2) reactant gas, 3) steam, 4) heat transfer aid particles, or 5) any of the four into the radiant heat chemical reactor. A chemical reaction driven by radiant heat occurs in the reactor tubes.

The chemical reaction may be an endothermic reaction including one or more of 1) biomass gasification (CnHm+H20→CO+H2+H20+X), 2) and other similar hydrocarbon decomposition reactions, which are conducted in the radiant heat chemical reactor using the radiant heat. A steam (H2O) to carbon molar ratio is in the range of 1:1 to 1:4, and the temperature is high enough that the chemical reaction occurs without the presence of a catalyst.

The biomass particles used as a feed stock into the radiant heat reactor design conveys the beneficial effects of increasing and being able to sustain process gas temperatures of excess of 1200 degrees C. through more effective heat transfer of radiation to the particles entrained with the gas, increased gasifier yield of generation of syngas components of carbon monoxide and hydrogen for a given amount of biomass fed in, and improved process hygiene via decreased production of tars and C2+ olefins. The control system for the radiant heat reactor matches the radiant heat transferred from the surfaces of the reactor to a flow rate of the biomass particles to produce the above benefits.

The control system controls the gas-fired burners to supply heat energy to the chemical reactor to aid in causing the radiant heat driven chemical reactor to have a high heat flux. The inside surfaces of the chemical reactor are aligned to 1) absorb and re-emit radiant energy, 2) highly reflect radiant energy, and 3) any combination of these, to maintain an operational temperature of the enclosed ultra-high heat flux chemical reactor. Thus, the inner wall of the cavity of the refractory vessel and the outer wall of each of the one or more tubes emits radiant heat energy to, for example, the biomass particles and any other heat-transfer-aid particles present falling between an outside wall of a given tube and an inner wall of the refractory vessel. The refractory vessel thus absorbs or reflects, via the tubes, the concentrated energy from the burners positioned either inside the tubes or external to the refractory vessel with hot products of combustion flowing inside the tubes to generally convey that heat flux to the biomass particles, heat transfer aid particles and reactant gas inside the chemical reactor. The inner wall of the cavity of the thermal refractory vessel and the multiple tubes act as radiation distributors by either absorbing radiation and re-radiating it to the heat-transfer-aid particles or reflecting the incident radiation to the heat-transfer-aid particles. The radiant heat chemical reactor uses an ultra-high heat flux and high temperature that is driven primarily by radiative heat transfer, and not convection or conduction.

Convection biomass gasifiers used generally on coal particles typically at most reach heat fluxes of 5-10 kW/m̂2. The high radiant heat flux biomass gasifier will use heat fluxes significantly greater, at least three times the amount of those found in convection driven biomass gasifiers (i.e. greater than 25 kW/m̂2). Generally, when using radiation at high temperature (>950 degrees C. wall temperature), much higher fluxes (high heat fluxes greater than 80 kW/m̂2) can be achieved with the properly designed reactor. In some instances, the high heat fluxes can be 100 kW/m̂2-250 kW/m̂2.

Next, the various algorithms and processes for the control system may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below. In general, the program modules may be implemented as software instructions, Logic blocks of electronic hardware, and a combination of both. The software portion may be stored on a machine-readable medium and written in any number of programming languages such as Java, C++, C, etc. but does not encompass transitory signals. The machine-readable medium may be a hard drive, external drive, DRAM, Tape Drives, memory sticks, etc. Therefore, the algorithms and controls systems may be fabricated exclusively of hardware logic, hardware logic interacting with software, or solely software.

While some specific embodiments of the design have been shown the design is not to be limited to these embodiments. For example, the recuperated waste heat from various plant processes can be used to pre-heat combustion air, or can be used for other similar heating means. Regenerative gas burners or conventional burners can be used as a heat source for the furnace. The Steam Methane Reforming may be/include a SHR (steam hydrocarbon reformer) that cracks short-chained hydrocarbons (<C20) including hydrocarbons (alkanes, alkenes, alkynes, aromatics, furans, phenols, carboxylic acids, ketones, aldehydes, ethers, etc., as well as oxygenates into syngas components. The design is to be understood as not limited by the specific embodiments described herein, but only by scope of the appended claims.

1. A chemical plant, comprising:
a radiant heat-driven chemical reactor having a generally cylindrical pressure refractory lined vessel, a plurality of radiant heating tubes, and a metal tube sheet cooperating to form a seal for the pressure refractory lined vessel near a top end of the pressure refractory lined vessel, where the metal tube sheet has a plurality of injection ports extending through the metal tube sheet, where the pressure refractory lined vessel, the plurality of radiant heating tubes, and the plurality of injection ports extending through the metal tube sheet are configured to 1) gasify particles of biomass in a presence of steam (H2O) to produce a low CO2 synthesis gas that includes hydrogen, carbon monoxide gas and less than 15% CO2 by total volume generated in a gasification reaction of the particles of biomass, 2) reform natural gas in a non-catalytic reformation reaction, and 3) any combination of both, using thermal energy from radiant heat, wherein the plurality of radiant heating tubes and the refractory lined vessel are geometrically configured to cooperate such that heat is radiantly transferred to 1) the particles of biomass, 2) the natural gas, and 3) any combination of both, passing through the refractory lined vessel, wherein the plurality of radiant heating tubes and the refractory lined vessel are geometrically configured to cooperate such that heat is radiantly transferred by primarily absorption and re-radiation, as well as secondarily through convection, and conduction to reacting particles to drive the biomass gasification reaction, or the natural gas non-catalytic reformation reaction, of reactants flowing through the radiant heat-driven reactor; wherein a heat source is in thermal communication with the radiant heating tubes to internally heat each tube such that heat exchanges through a wall of that tube to an interior environment of the refractory lined vessel where 1) the particles biomass, 2) the natural gas, or 3) any combination of both, is flowing to cause an operating temperature of between 900 degrees C. to 1600 degrees C. in the radiant heat-driven chemical reactor.

2. The chemical plant of claim 1, where the plurality of radiant heating tubes are arranged in an interior cavity of the refractory lined vessel along with the plurality of injection ports such that an injection of 1) the particles of biomass, 2) the natural gas, and 3) any combination of both, flows through a length of the refractory lined vessel, where the refractory lined vessel also includes two or more outlet ports for removing solids and gasses from the vessel, where the chemical reactor is in fluid communication with a steam supply of the steam, where the radiant heating tubes and the steam cooperate in order to provide enough energy required for the 1) gasification reaction of the particles of biomass, 2) the non-catalytic reformation reaction of the natural gas, and 3) any combination of both, in order to drive that reaction primarily with the radiant heat to produce the synthesis gas with a low amount of CO2; where the plurality of radiant heating tubes extend through the metal tube sheet and into and throughout an upper section of the refractory lined vessel, wherein a first port cooperates with an ash removal mechanism configured to remove ash remnants resulting from the biomass gasification reaction or the natural gas non-catalytic reformation reaction and a second port is configured to remove resultant product gasses from a lower portion of the vessel, wherein the second port for the resultant product gasses is located above the ash removal mechanism such that less ash remnants and particulate are being carried out of an exit of the chemical reactor along with the departing resultant product gasses.

3. The chemical plant of claim 2, wherein a quench zone is contained within the refractory lined vessel to quench at least the resultant product gasses, and the ash remnants are removed at a bottom of the refractory lined vessel after the quench occurs.

4. The chemical plant of claim 1, where the plurality of radiant heating tubes have high heat tolerant seals where they insert through the metal tube sheet, where the heat source is one or more gas fired heaters, which provide heat to the interior environment of the refractory lined vessel by way of a plurality of gas-fired radiant burners via the radiant tubes, where each of the radiant heating tubes comprises 1) a closed ceramic tube or 2) a ceramic tube with one end in which heat is supplied from another end and into an interior of the radiant heating tube, where the radiant heating tubes extend into an interior cavity of the refractory lined vessel to heat the injected biomass or the natural gas, and where the radiant heating tubes are aligned with a longitudinal axis of the refractory lined vessel such that the tubes are oriented substantially parallel to a flow path of the injected biomass or natural gas.

5. The chemical plant of claim 4, wherein walls of the refractory lined vessel are comprised of materials having low heat transfer rate characteristics and the plurality of radiant heating tubes are comprised of materials having high heat transfer rate characteristics, such that biomass particles within the refractory lined vessel are heated to a temperature high enough for substantial tar destruction to less than 200 mg/m̂3 and preferably less than 50 mg/m̂3, and a gasification of greater than 80 percent of a carbon content of the particles of biomass into reaction products including the hydrogen and the carbon monoxide gas.

6. The chemical plant of claim 5, wherein the heat source is coupled to the radiant heat-driven chemical reactor and configured to provide heat to the interior environment of the refractory lined vessel by way of a plurality of gas fired radiant burners, each of which gas fired radiant burners comprises the closed ceramic tube in which the heat is supplied to the interior of the ceramic tube, wherein the ceramic tubes are aligned with a horizontal axis of the refractory lined vessel such that the ceramic tubes are oriented substantially perpendicular to the flow path of the injected particles of biomass or natural gas, where the plurality of gas fired radiant burners project from a side wall of the refractory lined vessel and the heat source is an external recuperative or regenerative burner that supplies hot gas to the plurality of ceramic tubes via a manifold.

7. The chemical plant of claim 5, wherein the plurality of radiant heating tubes is arranged along an upper portion of the refractory lined vessel, substantially parallel to the flow path of the injected particles of biomass or natural gas, and the plurality of radiant heating tubes extends to only a portion of the way down a length of the refractory lined vessel.

8. The chemical plant of claim 1, wherein an entrainment gas source is coupled to the refractory lined vessel and configured to provide an entrainment gas at a high velocity to carry the biomass particles, entering at the top end of the refractory lined vessel by way of the plurality of injection ports, such that the biomass particles and the entrainment gas travel downward through the refractory lined vessel, where the plurality of radiant heating tubes and the plurality of injection ports are attached to the top end of the refractory lined vessel, such that each of the plurality of radiant heating tubes and corresponding injection ports are interspersed in a grid pattern in the metal tube sheet at the top of the refractory lined vessel.

9. The chemical plant of claim 8, wherein the refractory lined vessel further comprises the plurality of injection ports positioned along a side wall of the refractory lined vessel, where the plurality of injection ports is configured to inject biomass along a length of the plurality of radiant heating tubes, thereby facilitating a substantially uniform heat flux distribution along the length of the plurality of radiant heating tubes.

10. The chemical plant of claim 2, wherein the lower portion of the refractory lined vessel is either tapered or concave so as to direct the ash remnants toward the first port at an apex of the lower portion, and wherein the second port further comprises a diagonally angled baffle above the second port configured to direct the ash remnants and particulates to the lower portion of the refractory lined vessel and prevent the resultant product gases from migrating back up into the plurality of radiant heating tubes.

11. The chemical plant of claim 2, wherein the refractory lined vessel includes a first outlet and a second outlet, the first outlet being configured for the ash removal mechanism at the lower portion of the refractory lined vessel to remove ash and the second outlet being positioned above the first outlet and configured to collect the resultant product gases including syngas, where the first outlet is configured to cooperate with a moving collection bed below the refractory lined vessel for the ash removal, and where the second outlet conveys the resultant product gases to an external quench unit.

12. The chemical plant of claim 2, wherein the refractory lined vessel includes an internal quench zone located between a bottom of the plurality of radiant heating tubes and a bottom of the refractory lined vessel, and wherein the refractory lined vessel comprises an outlet for solids and an outlet for gases.

13. The chemical plant of claim 1, where the radiant heat-driven chemical reactor is configured in a recuperative configuration, where 1) the biomass particles react in a decomposition reaction to produce syngas and other product gases, or 2) the natural gas undergoes a steam reformation reaction, both of which reactions potentially leave a small amount of carbon black on walls of the radiant heat-driven chemical reactor and the plurality of radiant heating tubes, where after operating in a syngas production mode and having the biomass particles and/or the natural gas supplied for a period of time, the radiant heat-driven chemical reactor is then shifted into a cleanup mode during which a number of chemical agents, such as steam, carbon dioxide gas, or other suitable gases, are supplied to the reactor so as to remove the small amount of carbon black from the walls of the radiant heat-driven chemical reactor and the plurality of radiant heating tubes.

14. The chemical plant of claim 13, wherein one or more gases resulting from removal of the carbon black from the walls of the radiant heat-driven chemical reactor and the plurality of radiant heating tubes is supplied to a downstream process in the chemical plant.

15. The chemical plant of claim 7, wherein the plurality of radiant heating tubes extend through the metal tube sheet and each of the plurality of radiant heating tubes is sealed into the metal tube sheet, where pressure inside the refractory lined vessel operates to push the radiant heating tubes into the seals, and the seals are located at a point where the biomass particles being injected into the refractory lined vessel are subjected to a temperature cooler than a temperature of the reaction within the refractory lined vessel, thereby allowing the seals to be comprised of a material having a lower resistance to temperature than if the seals were positioned within the refractory lined vessel.

16. The chemical plant of claim 1, wherein the radiant heat-driven chemical reactor comprises a refractory lined pressure vessel with a plurality of radiant heat surfaces projecting into an interior cavity of the refractory lined pressure vessel.

17. The chemical plant of claim 16, wherein the plurality of radiant heat surfaces comprises a plurality of radiant heating tubes whereby heat is supplied to the interior cavity from an inside of the plurality of radiant heating tubes.

18. The chemical plant of claim 17, wherein the refractory lined pressure vessel is generally cylindrical and the plurality of radiant heating tubes are oriented parallel to a longitudinal axis of the refractory lined pressure vessel, wherein the plurality of radiant heating tubes comprises SiC in compression, due to pressure within the refractory lined pressure vessel, and are interspersed among 10-200 injection ports configured to inject a biofeed into the interior cavity, and wherein a solids flow and a gas flow into the interior cavity can be independently controlled around each of the plurality of radiant heating tubes, such that if one of the plurality of radiant heating tubes is non-operative, the injection ports adjacent the one of the plurality of radiant heating tubes may be shut off while permitting the rest of the plurality of radiant heating tubes to function.

19. The chemical plant of claim 17, wherein the refractory lined pressure vessel is generally cylindrical and the plurality of radiant heating tubes is oriented perpendicular to a longitudinal axis of the refractory lined pressure vessel, wherein biomass and an entrainment gas are injected into the interior cavity in a plurality of locations between each of the plurality of radiant heating tubes, and wherein the refractory lined pressure vessel includes at least one outlet for resultant solids and gases.

20. The chemical plant of claim 1, wherein the refractory lined vessel is oriented generally vertical, such that biomass particles are injected at the top end of the refractory lined vessel and travel downward toward a bottom of the refractory lined vessel, wherein a solids outlet is at the bottom and a gas outlet is adjacent and above the solids outlet, wherein a lower portion of the refractory lined vessel is inwardly tapered, wherein the plurality of radiant heating tubes terminate prior to the lower portion of the refractory lined vessel, and wherein the lower portion comprises a quench zone.
